(19) United States
(12) Patent Application Publication
(10) Pub. No.: US 2011/0161042 A1
(43) Pub. Date: Jun. 30, 2011

(54) Hinged Device With Multiple Accelerometers

(76) Inventors: Robert E. Krancher, Houston, TX (US); Jeffrey Kevin Jeansonne, Houston, TX (US)

(21) Appl. No.: 13/058,331

(22) PCT Filed: Sep. 19, 2008
(86) PCT No.: PCT/US08/76970

§ 371 Date: Mar. 15, 2011

Related U.S. Application Data
(60) Provisional application No. 61/087,944, filed on Aug. 11, 2008.

(51) Int. Cl. G06F 15/00; G01P 15/00

(52) U.S. Cl. 702/141

(57) ABSTRACT

Apparatus, systems and methods for determining relative spatial orientation of a first member and a second member connected by one or more hinges are provided. A first member having one or more first accelerometers disposed therein can provide a first signal proportionate to the acceleration of the first member along one or more axes. A second member having one or more second accelerometers disposed therein can provide a second signal proportionate to the acceleration of the second member along one or more axes. One or more hinges can pivotably connect the first and second members. A controller can receive the first signal provided by the one or more first accelerometers and the second signal provided by the one or more second accelerometers to calculate the spatial orientation of the first member with respect to the second member.

### CROSS REFERENCE TO RELATED APPLICATIONS

This application claims the benefit of provisional patent application Ser. No. 61/087944, filed Aug. 11, 2008, titled “Hinged Device With Multiple Accelerometers.”

### BACKGROUND OF THE INVENTION

1. Field of the Invention

Embodiments of the present invention generally relate to systems and methods for determining the spatial configuration of a hinged device. More particularly, embodiments of the present invention relate to systems and methods for determining the spatial configuration of a hinged device using two or more accelerometers.

2. Description of the Related Art

This section is intended to introduce the reader to various aspects of art which may be related to one or more aspects of the present invention as described and claimed below. This discussion is believed helpful in providing the reader with background information, thereby facilitating a better understanding of various aspects of the present invention. Accordingly, it should be understood by the reader that the provided information should be read in this light and not as an admission of prior art.

Electronic devices, from smaller handheld devices such as portable or cellular telephones and personal data assistants (“PDAs”) to larger portable devices such as laptop or portable computers, often make use of a housing having two or more connected members. For example, cellular telephones often have a first member containing a display and a second member containing one or more input devices such as keys or buttons permitting the entry of data, for example text messages or telephone numbers, into the device. Similarly, laptop and/or portable computers often have a first member containing a display, and a second member containing one or more input devices such as a keyboard, touchpad or the like. Regardless of the type of device, the connection between the first and second members usually includes mechanical affixation and electrical connection. While various types of mechanical affixation exist, the most popular means for attaching the first and second members is through the use of one or more hinges permitting the rotation of the first member through an arc of about 0° to about 180° with respect to the second member.

The relative spatial orientation between the first and second members varies depending on the use of the device. Often the relative spatial orientation of the first and second members can provide a reliable indication of the user's intent. For example, a relative spatial orientation of 0° can indicate that the user has “closed” the device, while a relative spatial orientation of greater than 0° can indicate that the user has “opened” the device. The relative spatial orientation than therefore provide valuable insight as to the user's intent to use the device (e.g. by “opening” the device) or to discontinue use of the device (e.g. by “closing” the device).

There is a need, therefore, for improved systems and methods for determining the relative spatial orientation between two or more hinged members forming an electronic device.

### SUMMARY OF THE INVENTION

An apparatus for determining relative spatial orientation of a two piece hinged body is provided. A first member having one or more first accelerometers disposed therein can provide a first signal proportionate to the acceleration of the first member along one or more axes. A second member having one or more second accelerometers disposed therein can provide a second signal proportionate to the acceleration of the second member along one or more axes. One or more hinges can pivotably connect the first and second members. A controller can receive a first signal provided by the one or more first accelerometers and a second signal provided by the one or more second accelerometers. The controller can use the first and second signals to calculate the spatial orientation of the first member with respect to the second member.

A method for determining relative spatial orientation of a two-piece hinged body is also provided. A first accelerometer disposed in, on, or about a first member can provide a first signal, proportionate to the acceleration of the first member. A second accelerometer disposed in, on, or about a second member can provide a second signal, proportionate to the acceleration of the second member. Using the first and second signals, a controller can determine the relative spatial orientation of the first and second members. The controller can generate one or more output signals when the relative spatial orientation of the first and second members exceeds a predetermined threshold.

### BRIEF DESCRIPTION OF THE DRAWINGS

A more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may encompass other equally effective embodiments.

Advantages of one or more disclosed embodiments may become apparent upon reading the following detailed description and upon reference to the drawings in which:

FIG. 1 depicts an illustrative device in a first position where two hinged members are disposed at an angle greater than 0°, according to one or more embodiments described;

FIG. 2 depicts the illustrative device shown in FIG. 1 in a second position where the two hinged members are disposed at an angle of about 0°, according to one or more embodiments described;

FIG. 3 depicts an illustrative logic flow diagram for enabling one or more inputs and/or outputs in response to the spatial orientation of the first member 110 and second member 120 according to one or more embodiments described.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions is described in greater detail below, including specific embodiments, versions and examples, but the inventions are not limited to these embodiments, versions or examples, which are included to enable a person having ordinary skill in the art to make and use the inventions, when the information in this patent is combined with available information and technology.

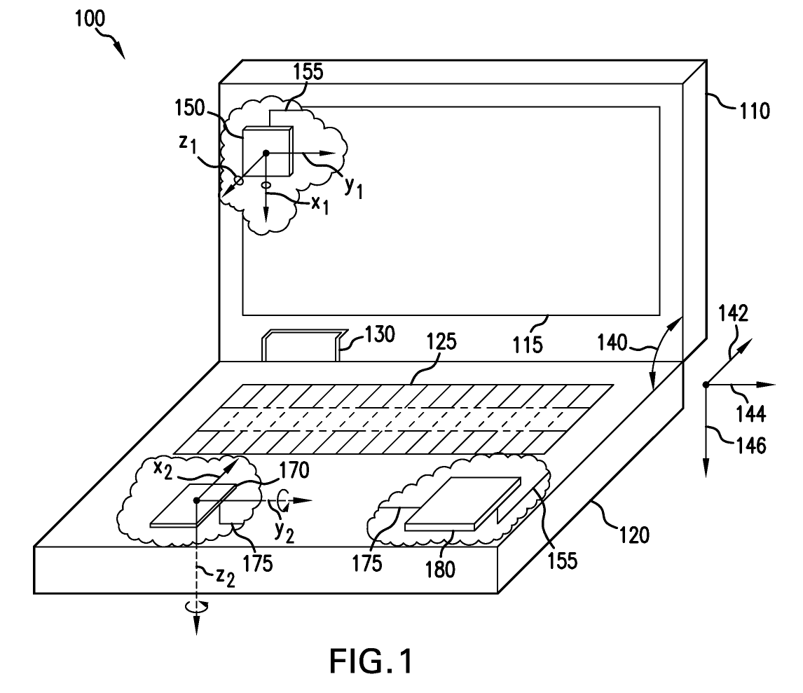

FIG. 1 depicts an illustrative device having two pivotably connected members disposed at an angle 140 that exceeds 0°, according to one or more embodiments. The device 100 can include a first member 110, a second member 120, and one or more hinges 130 interposed between, and pivotably connecting, the first and second members 110 and 120. One or more accelerometers (“first accelerometers”) 150 can be disposed in, on, or about the first member 110 to measure the accelerative forces, for example the gravitational force of the earth, imposed on the first member 110. In a similar manner, one or more accelerometers (“second accelerometers”) 170 can be disposed in, on, or about the second member 120 to measure the accelerative forces imposed on the second member 120.

One or more controllers 180 can be disposed in, on, or about the first and/or second members 110 and 120. One or more first signals, proportionate to the acceleration measured along one or more axes by the first accelerometer 150, can be transmitted to the controller 180 via one or more communications conduits 155. In one or more specific embodiments, the one or more first signals can be a set of discrete signals or a single composite signal proportionate to the acceleration measured along two or more orthogonal axes by the first accelerometer 150. The one or more first signals can be linearly or non-linearly, directly or indirectly proportionate to the accelerative forces imposed on the first accelerometer 150. One or more second signals, proportionate to the acceleration measured along one or more axes by the second accelerometer 170, can be transmitted to the controller 180 via one or more communications conduits 175. The one or more second signals can be linearly or non-linearly, directly or indirectly proportionate to the accelerative forces imposed on the second accelerometer 170. In one or more specific embodiments, the one or more second signals can be a set of discrete signals or a single composite signal proportionate to the acceleration measured along two or more orthogonal axes by the second accelerometer 170.

The controller 180 can calculate the relative differences in acceleration experienced by the first and second accelerometers 150 and 170 to determine the relative spatial orientation of the first and second members 110 and 120. The controller 180 can be a stand-alone device or incorporated into a multi-function device, for example a motherboard chipset disposed within a laptop or portable computer. In one or more specific embodiments, the controller 180 can be incorporated into one or more processors, the central processing unit or CPU, disposed within a laptop or portable computer, cell-phone, personal data assistant (PDA) or the like.

Determination of the spatial orientation of the first member 110 with respect to the second member 120 can be useful, for example, in enabling one or more input and/or output devices, entering or exiting one or more low power demand states, and entering or exiting one or more high power demand states. The controller 180 can have one or more outputs useful for reversibly switching one or more input and/or output devices from a “standby” state to an “active” state and vice-versa. For example the controller 180 can be disposed within a cellular telephone, laptop computer, or portable computer which can switch from a “standby” or “hibernate” mode to an “active” mode when the relative spatial orientation between the first and second members 110 and 120 exceeds a predetermined threshold. Similarly, the controller 180 can switch the cellular telephone, laptop computer, or portable computer from the “active” mode to the “standby” or “hibernate” mode when the relative spatial orientation between the first and second members 110 and 120 drops below the predetermined threshold. In one or more embodiments, the predetermined threshold for switching between “standby” and “active” states can be a minimum of about 10°, about 20°, about 30°, about 40°, about 45°, or about 50°.

In one or more embodiments, the first and second accelerometers 150 and 170 can include any system, device, or combination of systems and/or devices suitable for measuring the acceleration of a body along one axis and generating one or more signals proportionate thereto. In one or more embodiments, the first and second accelerometers 150 and 170 can include any device suitable for measuring the acceleration along two or more orthogonal axes and producing one or more signals proportionate thereto for each axis along which acceleration can be measured. In one or more embodiments, the one or more accelerometers 150 and 170 can include accelerometers using one or more acceleration measurement technologies, including, but not limited to piezoelectric, potentiomnetric, reluctive, servo, strain gauge, capacitive, vibrating element, or any combination thereof. In one or more embodiments the first and second accelerometers 150 and 170 can have a sensitivity of from about +10 g to about −10 g; about +5 g to about −5 g; about +3 g to about −3 g; about +2 g to about −2 g; or about +1 g to about −1 g. In one or more embodiments, the first and second accelerometers 150 and 170 can have identical sensitivity ranges. In one or more embodiments, the first and second accelerometers 150 and 170 can have differing sensitivity ranges. In one or more specific embodiments, the first and second accelerometers 150 and 170 can have identical sensitivity ranges of about −3 g to about +3 g.

In one or more specific embodiments, the first and second accelerometers 150 and 170 can include one or more solid-state accelerometers using any one or more of the aforementioned acceleration measurement technologies. The one or more first accelerometers 150 can be disposed in, on, or about the first member 110. In one or more specific embodiments, the one or more first accelerometers 150 can be a solid state device, for example a single chip, a chipset or other similar circuit mounted directly to one or more circuit boards disposed in, on, or about the first member 150, The one or more second accelerometers 170 can be disposed in, on, or about the second member 120. In one or more specific embodiments, the one or more second accelerometers 170 can be a solid state device, for example a single chip, a chipset or other similar circuit mounted directly to one or more circuit boards disposed in, on, or about the second member 170.

The one or more first and second accelerometers 150 and 170 can include devices suitable for measurement of linear acceleration along one or more axes. In one or more embodiments, the one or more first and second accelerometers 150 and 170 can be single axis accelerometers, each providing an output signal proportionate to the acceleration along a single axis. In one or more embodiments, the one or more first and second accelerometers 150 and 170 can include multi-axis accelerometers, each providing one or more output signals proportionate to the acceleration along two or more common orthogonal reference axes, for example along an x-axis 142, a y-axis 144, and a z-axis 146 as depicted in FIG. 1.

One or more input/output devices 115 can be disposed in, on, or about the first member 110. In a like manner, one or more input/output devices 125 can be disposed in, on or about the second member 120. In one or more specific embodiments, one or more output devices 115, for example an LCD display, a CRT display, a speaker, or the like can be disposed in, on, or about the first member 110. In one or more specific embodiments, one or more input devices 125, for example a mouse, a touchpad, a keyboard, or the like can be disposed on, in, or about the second member 120. In one or more specific embodiments, the first member can have any combination of input and output devices disposed in, on or about the first member. For example, an LCD display (output device) and a video camera (input device) can be disposed in the first member 110. In similar fashion, a keyboard (input device) and one or more speakers (output device) can be disposed in, on, or about the second member 120.

In one or more specific embodiments, the device 100 can be a laptop or portable computer having one or more output devices 115, such as an LCD display, disposed in, on, or about the first member 110, and one or more input devices 125, such as a keyboard and mouse disposed in, on, or about the second member 120. In one or more specific embodiments, the device 100 can be a conventional or cellular telephone having one or more output devices 115, such as a backlit TFT display, disposed in, on, or about the first member, and one or more input devices 125, such as a twelve button keypad, disposed in, on, or about the second member 120.

The one or more hinges 130 can provide a flexible mechanical and electrical coupling between the first member 110 and the second member 120. In one or more embodiments, the hinge 130 can permit the rotation of the first member 110 through an angle 140 of from about 0° to about 180° measured with respect to the second member 120. In one or more embodiments, the hinge 130 can have multiple degrees of freedom, permitting the rotation of the first member 110 about two or more axes with respect to the second member 120, such an installation would be particularly advantageous in devices having touch sensitive screens which are commonly used in a flat, or “tablet” configuration. For example, the hinge 130 can permit the rotation of the first member 110 through an arc of about 0° to about 180° along a first axis, for example the y-axis 144, parallel to the longitudinal axis of the first member 110, and through an arc of about 0° to about 180° along second axis, for example the z-axis 146, perpendicular to the longitudinal axis of the first member 110. The first member 110 and the second member 120 can be electrically coupled via one or more conductors routed in, or along the one or more hinges 130.

While the first and second accelerometers 150 and 170 can include any number or combination of single, dual or multi-axis accelerometers, for simplicity and ease of explanation, the operation of a non-limiting, exemplary system containing a single, three-axis, first accelerometer 150 and a single, three-axis second accelerometer 170 will be described hereinafter. The forces experienced by the first accelerometer 150 can be transmitted as a one or more first signals x₁, proportionate to the force experienced along the x-axis of the first accelerometer 150; y₁, proportionate to the force experienced along the y-axis of the first accelerometer 150: and z₁, proportionate to the force experienced along the z-axis of the first accelerometer 150. Similarly, the forces experienced by the second accelerometer 170 can be transmitted as one or more second signals x₂, proportionate to the force experienced along the x-axis of the second accelerometer 170; y₂, proportionate to the force experienced along the y-axis of the second accelerometer 170; and z₂, proportionate to the force experienced along the z-axis of the second accelerometer 170. In one or more embodiments, the x-axis, y-axis and z-axis of the second accelerometer 170 can be in substantial alignment with the reference x-axis 142, y-axis 144, and z-axis 146 when the hinged device is disposed at an angle 140 of about 0°.

The one or more first signals can be transmitted from the first accelerometer 150 to the controller 180 via the one or more conduits 155. In one or more embodiments, the one or more first signals x₁, y₁, and z₁ can be proportionate to the acceleration experienced along the x-axis, y-axis and z-axis (respectively) of the first accelerometer 150. The one or more second signals can be transmitted from the second accelerometer 170 to the controller 180 via the one or more conduits 175. In one or more embodiments, the one or more second signals x₂, y₂, and z₂ can be proportionate to the acceleration experienced along the x-axis, y-axis and z-axis (respectively) of the second accelerometer 170. Within the controller 180, the first signal transmitted via conduit 155 and the second signal transmitted via conduit 175 can be compared and the resultant comparison used to determine the spatial orientation of the first member 110 with respect to the second member 120. In one or more specific embodiments, the controller 180 can include one or more outputs to toggle or otherwise transition the first member 110 and/or second member 120 between one or more high power demand states and one or more low power demand states.

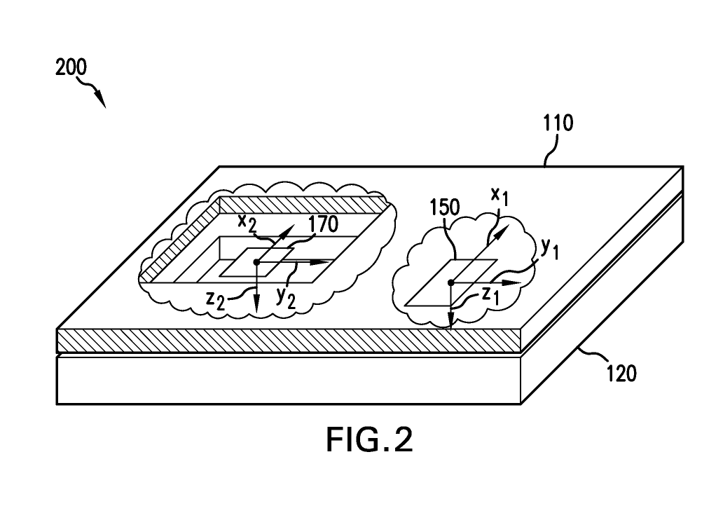

FIG. 2 depicts the illustrative device shown in FIG. 1 in a second position where the first member 110 and the second member 120 are disposed at an angle 140 of about 0°, i.e. substantially parallel to each other, according to one or more embodiments. When the first member 110 and the second member 120 are disposed at an angle 140 of about 0° as depicted in FIG. 2, the x-axes, y-axes, and z-axes of the first and second accelerometers, 150 and 170 respectively, can be disposed in substantial alignment with the x-axis 142, y-axis 144, and z-axis 146. When disposed at an angle 140 of about 0° as depicted in FIG. 2, the signals generated by the first and second accelerometers 150, 170, will be similar, for example: x₁=x₂=0 g; y₁=y₂=0 g; z₁=z₂=1 g. Thus, at an angle 140 of about 0°, the difference between signals along all three axes can be calculated as follows: x₁−x₂=0; y₁−y₂=0; z₁−z₂=0.

As the first member 110 is pivoted about one or more hinges 130, the angle 140 between the first and second members will increase as the first member 110 is pivoted away from the second member 120. At an angle 140 of about 45°, the signals generated by the first and second accelerometers 150 and 170 can be about: x₁=0.5 g; x₂=1 g; y₁=y₂=0 g; z₁=0.5 g; z₂=0 g. At an angle 140 of about 45°, the difference between signals along all three axes can be calculated by the controller 180 as follows: x₁−x₂=−0.5; y₁−y₂=0; z₁−z₂=0.5. Similarly, at an angle 140 of about 90°, the signals generated by the accelerometers 150 and 170 can be about: x₁=0 g; x₂=1 g; y₁=y₂=0 g; z₁=1 g; z₂=0 g. At an angle 140 of about 90°,the difference between signals along all three axes can be calculated by the controller 180 as follows: x₁−x₂=−1; y−y₂=0; z₁−z₂=1. Thus, at varying angles 140 between the first member 110 and the second member 120, the calculated difference between the first and second signals can provide one or more sets of values indicative of the relative spatial orientation, or position, of the first member 110 with respect or reference to the second member 120.

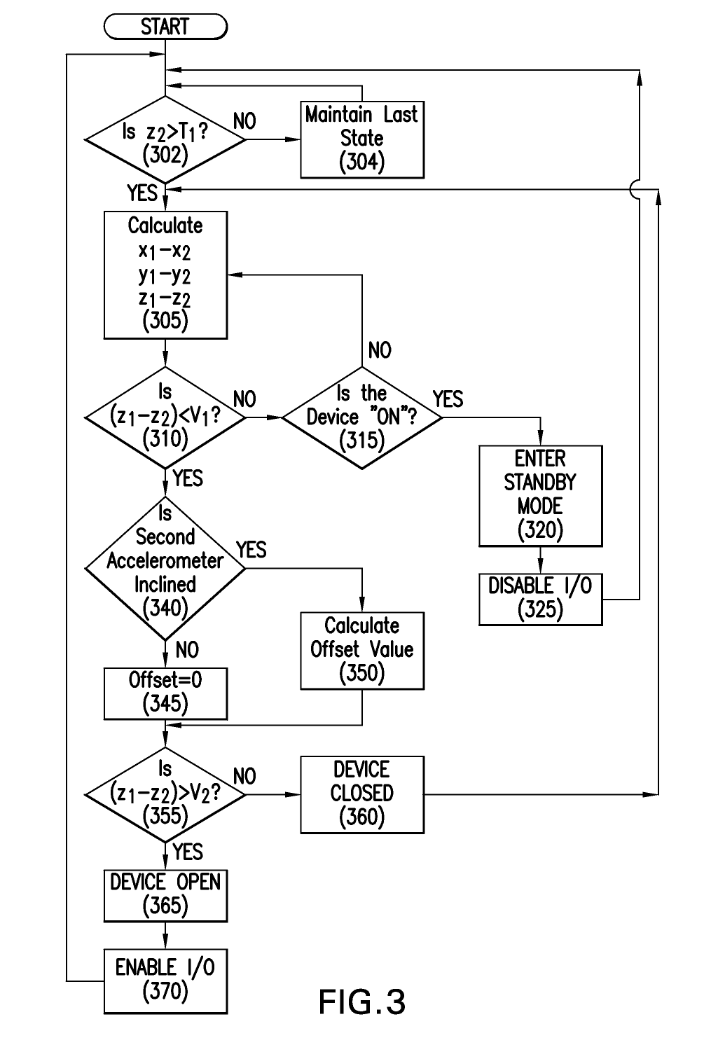

FIG. 3 depicts an illustrative logic flow diagram for enabling one or more inputs and/or outputs in response to the spatial orientation of the first member 110 and second member 120 according to one or more embodiments. In one or more embodiments, the first signal communicated along conductor 155 and the second signal communicated along conductor 175 can provide a plurality of inputs to the one or more controllers 180. The one or more controllers 180 can include, but are not limited to one or more central processing units (CPU), one or more keyboard controllers, one or more input/output controllers, one or more video controllers, or the like.

Within the one or more controllers 180, at step 302, the force exerted by gravitational acceleration along the z-axis of the second accelerometer 120, z₂, can be examined. If the value of the force z₂ exceeds a first threshold value, T₁, the device 100 is oriented substantially parallel to the gravitational field surrounding the device, and further processing by the controller 180 is enabled. If the value of the acceleration experienced by the second member 120 along the z-axis is less than or equal to the first threshold value T₁ the device 100 is oriented substantially normal to the gravitational field surrounding the device, and further processing by the controller is inhibited until the force z₂ increases above the first threshold value, T₁. While force z₂ remains below the first threshold value T₁, the device 100 is maintained in the last state in step 304. In one or more embodiments, the first threshold value T₁ can be about 0.05 g or more; about 0.1 g or more; about 0.25 g or more; or about 0.5 g or more.

After confirming that the force z₂ is greater than the first threshold value T₁ in step 302, the controller 180 can calculate the difference between the first and second signals, i.e. (x₁−x₂), (y₁−y₂), and (z₁−z₂), providing a differential acceleration value along each axis in step 305.

In step 310, if the calculated difference along the z-axis is less than a threshold value V₁, the controller determines whether the device is “ON,” for example in a high power demand state, in step 315. If the device is not “ON” then the control returns to the differential calculation in step 305. If the device is “ON,” the user has placed the device into a standby mode. The controller can cause the device 100 to enter the standby mode in step 320, disabling one or more inputs and/or outputs in step 325. After disabling the one or more inputs and/or outputs in step 325, control can be returned to step 302. In one or more embodiments, the threshold value V₁ can be about 0.5 g or less; about 0.25 g or less; about 0.1 g or less; about 0.05 g or less; or about 0.01 g or less.

If the controller 180 determines that the calculated difference in acceleration along the z-axis, (z₁−z₂), exceeds a first threshold value V₁, the controller 180 can then determine, in step 340, whether the second accelerometer 170 is inclined with respect to the surrounding gravitational field. If the controller, based upon the second signal from the second accelerometer 170, determines that the device 100 is inclined with respect to the surrounding gravitational field, the controller can calculate an offset in step 350 to compensate for the inclined position of the device 100, If the controller, based upon the second signal from the second accelerometer 170, determines that the device 100 is not inclined, the controller can set the offset to “0” in step 345.

If after compensating for any incline, the controller in step 355 determines the calculated difference in acceleration along the z-axis, (z₁−z₂), exceeds a second threshold value, V₂, the controller can signify that the device 100 is open in step 365. If after compensating for any incline, the controller in step 355 determines the calculated difference in acceleration along the z-axis, (z₁−z₂), is at or below the second threshold value, V₂, the controller can signify that the device 100 is closed and control can be returned to the differential calculation in step 305. In one or more embodiments, the second threshold value V₂ can be about 0.05 g or more; about 0.1 g or more; about 0.25 g or more; or about 0.5 g or more.

If the controller determines the device 100 is open in step 365, the controller can enable and/or disable one or more input and/or output devices in step 370. After enabling one or more input and/or output devices in step 370, control can be returned to step 302.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. An apparatus for determining relative spatial orientation of a two-piece hinged body, comprising:
a first member having one or more first accelerometers disposed therein to provide a first signal proportionate to the acceleration of the first member along one or more axes;
a second member having one or more second accelerometers disposed therein to provide a second signal proportionate to the acceleration of the second member along the one or more axes;
one or more hinges pivotably connecting the first and the second members; and
a controller to receive the first signal and the second signal and to calculate the spatial orientation of the first member with respect to the second member.

2. The apparatus of claim 1, further comprising one or more controller outputs to toggle the two-piece hinged body between one or more power demand states based upon the spatial orientation of the first member with respect to the second member.

3. The apparatus of claim 1, wherein the one or more first accelerometers and the one or more secondary accelerometers measure acceleration along two or more orthogonal axes.

4. The apparatus of claim 1, wherein the one or more first accelerometers and the one or more second accelerometers comprise one or more single axis accelerometers.

5. The apparatus of claim 1, wherein the one or more first accelerometers and the one or more second accelerometers comprise one or more piezoelectric accelerometers, potentiometric accelerometers, reluctive accelerometers, servo accelerometers, strain gauge accelerometers, capacitive accelerometers, vibrating element accelerometers, or any combination thereof.

6. The apparatus of claim 1, wherein the two-piece hinged device comprises a portable computer, a laptop computer, a cellular telephone, a personal data assistance, a portable PC, or any combination thereof.

7. The apparatus of claim 1, wherein the one or more hinges have two or more degrees of freedom, permitting the first member and the second member to rotate about two or more axes.

8. A method for determining relative spatial orientation of a two-piece hinged body, comprising:
disposing one or more first accelerometers within a first member;
disposing one or more second accelerometers within a second member;
generating one or more first signals from one or more first accelerometers, wherein the one or more first signals are proportional to acceleration along one or more axes in a set of orthogonal axes;
generating one or more second signals from one or more second accelerometers, wherein the one or more second signals are proportional to acceleration along one or more axes in the set of orthogonal axes;
transmitting the one or more first signals and the one or more second signals to one or more controllers;
calculating the difference along corresponding axes between the one or more first signals and the one or more second signals to provide a differential acceleration value along each axis which can provide an indication of relative spatial orientation between the first and second members; and
generating an output signal from the one or more controllers based upon the relative spatial orientation between the first and second members.

9. The method of claim 8, wherein the one or more first accelerometers measure acceleration along two or more orthogonal axes to provide the one or more first signals.

10. The method of claim 8, wherein the one or more second accelerometers measure acceleration along two or more orthogonal axes to provide the one or more second signals.

11. The method of claim 8, wherein the one or more first accelerometers comprise a plurality of single axis accelerometers, and wherein each of the one or more first accelerometers measures acceleration along a single axis to provide the one or more first signals.

12. The method of claim 8, wherein the one or more second accelerometers comprise a plurality of single axis accelerometers, and wherein each of the one or more second accelerometers measures acceleration along a single axis.

13. The method of claim 8, wherein the one or more devices comprise one or more input devices, one or more output devices, or any combination thereof.

14. The method of claim 8, wherein the hinge has two or more degrees of freedom, permitting the hinge to rotate about two or more axes.

15. A system for determining relative spatial orientation of a two-piece hinged body, comprising:
means for generating one or more first signals, wherein the one or more first signals are proportional to the acceleration of a first member along one or more axes in a set of orthogonal axes;
means for generating one or more second signals, wherein the one or more second signals are proportional to the acceleration of a second member along one or more axes in a set of orthogonal axes, and wherein the first member and the second member are pivotably connected using one or more hinges;
means for transmitting the one or more first signals and the one or more second signals to one or more controllers;
means for calculating a differential acceleration value along each axis; and
means for generating an output from the one or more controllers to interface with one or more devices based upon the calculated differential acceleration along one or more axes.
